(19) United States
(12) Patent Application Publication
(10) Pub. No.: US 2011/0069240 A1
(43) Pub. Date: Mar. 24, 2011

(54) Projector and Control Method Thereof

(76) Inventor: Dong-Hsing Su, Hsichih (TW)

(21) Appl. No.: 12/774,040

(22) Filed: May 5, 2010

(30) Foreign Application Priority Data
Sep. 23, 2009 (TW) 098132159

(51) Int. Cl. H04N 9/31

(52) U.S. Cl. 348/744; 348/E09.025

(57) ABSTRACT

A projector control method for a projector in a standby mode is disclosed. The projector is connected to an active video source for image projecting, and the projector comprises at least one input port. The method comprises the follow steps of: connecting electronically the projector and the video source via a video signal cable; detecting whether a defining signal is produced from the input port of the projector, wherein the defining signal is selected from one of the following: a current variation, a voltage variation, an encoded signal, a clock signal, and a synchronous signal; and supplying power to the projector and igniting a lamp when the defining signal is detected, such that the projector enters an active mode.

### BACKGROUND OF THE INVENTION

1. Field of the Invention

The present invention relates to a projector control method; more particularly, it relates to a projector control method capable of driving a projector by connecting a video signal cable and checking quickly the signal input port connected to a video source for projecting images.

2. Description of the Related Art

Generally, when a user wants to project images with a projector, he or she may use a video signal cable to connect the projector with a video source, such as a computer or a media player, and the video source may send video signals to the projector via the video signal cable. The user may press a power switch of the projector first, and the projector may be driven from a standby mode to an active mode. When the lamp of the projector is warmed up, the projector may emit light to project images. With developments in remote technology in recently years, the user may drive the projector conveniently with a remote control.

The projectors may comprise at least one kind of signal input ports, such as a VGA port, a DVI port, or an HDMI port. Furthermore, the projector may also comprise two or more of the same signal input ports. When the projector is driven every time, it may search all of the signal input ports in sequence to detect whether the video signal input is inputted. If the video signal is detected, the projector may project the image according to the video signal.

However, in the case of a notebook computer, unlike a desktop computer, which may be often disposed near the projector, when the user wants to project the images of the notebook computer with the projector, he or she must connect the projector to the notebook computer via a video signal cable and press the power button of the projector to search for the video source every time. It is not convenient for the user to use the projector.

### SUMMARY OF THE INVENTION

It is an object of the present invention to provide a projector control method capable of driving a projector by connecting a video signal cable and finding a correct signal input port.

To achieve the abovementioned object, a projector control method of the present invention is used for a projector in a standby mode, and the projector is connected to an active video source for image projecting. The method comprises the follow steps of: connecting electronically the projector and the video source via a video signal cable; detecting whether a defining signal is produced from the input port of the projector, wherein the defining signal is selected from one of the following: a current variation, a voltage variation, an encoded signal, a clock signal, and a synchronous signal; and supplying power to the projector and igniting a lamp when the defining signal is detected, such that the projector enters an active mode. Accordingly, when the video signal cable connected the video source connects to the projector, the projector will work to execute its projection functions without the necessity of the projector being turned on in a manual manner and the user searching for the signal.

The projector of the present invention applies to the aforementioned projector control method. The projector connects electronically to the active video source via a video signal cable. The projector comprises a lamp, an igniting module, a power module, at least one input port, and a microprocessor. The igniting module is used for igniting the lamp. The power module is used for supplying power to the projector. The at least one input port is used for connecting to the video signal cable. The microprocessor connects electronically to the igniting module, the power module, and each input port. The projector may check whether a certain input port is connected to the video source by the microprocessor detecting each input port to determine whether a defining signal is produced, wherein the defining signal is selected from one of the following: a current variation, a voltage variation, an encoded signal, a clock signal, and a synchronous signal. Then the microprocessor may notify the power module to supply power to the projector and notify the igniting module to ignite the lamp, such that the projector 10 may enter an active mode from a standby mode.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a schematic drawing of using an embodiment of a projector of the present invention.

FIG. 2 illustrates a main flowchart of a projector control method of the present invention.

FIG. 3 illustrates a schematic drawing of using another embodiment of a projector of the present invention.

FIG. 4 illustrates a main flowchart of the projector control method of the present invention applied to another embodiment of the projector.

### DETAILED DESCRIPTION OF THE PREFERRED EMBODIMENT

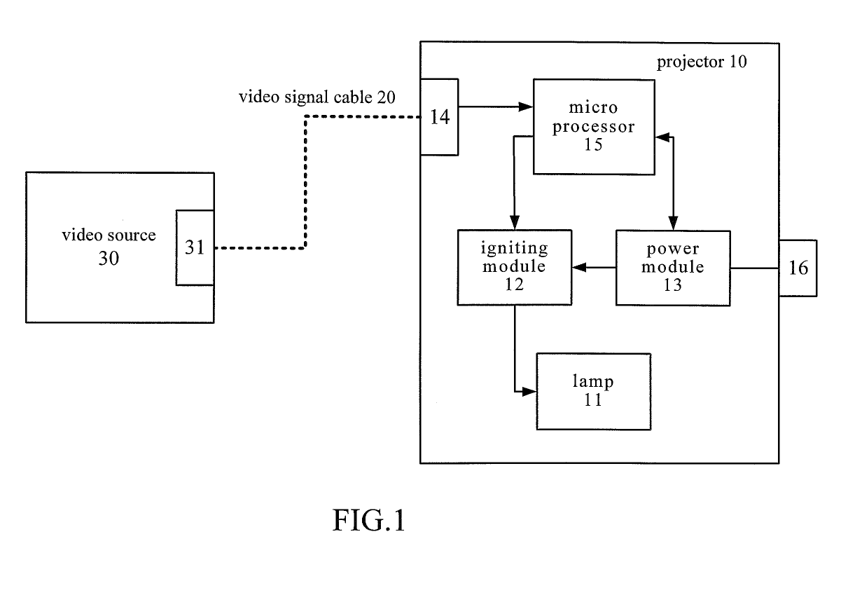

Please refer to FIG. 1 for a schematic drawing of using an embodiment of a projector 10 of the present invention. As shown in FIG. 1, a projector 10 of the present invention is connected electronically to an active video source 30 via a video signal cable 20. The video source 30 may transmit video signals to the projector 10 through the video signal cable 20. In this embodiment, the video source 30 may be a computer device, and the video signal cable 20 may be a VGA cable, a DVI cable, an HDMI cable, or other cables with similar functions. The video signal cable 20 may be selected according to a different output port 31 of the video source 30.

The projector 10 of the present invention comprises a lamp 11, an igniting module 12, a power module 13, an input port 14, a microprocessor 15, and a switch 16. The igniting module 12 is used for igniting the lamp 11 and transferring the power from the power module 13 into suitable current and voltage for the lamp 11. In one embodiment of the present invention, the igniting module 12 is a ballast, a starter, or other elements with similar functions, but please note that the scope of the present invention is not limited to the above description. The power module 13 is used for supplying power to each element of the projector 10. The input port 14 is used for connecting to the video signal cable 20 for receiving video signals from the video source 30.

The microprocessor 15 connects electronically to the igniting module 12, the power module 13, and the input port 14. When the projector 10 is in a standby mode, the power module 13 may still supply power to the microprocessor 15, and the microprocessor 15 may detect the input port 14 in real-time to determine whether a defining signal is produced. When the defining signal is detected from the input port 14, the microprocessor 15 may notify the power module 13 to supply power to the projector 10 and notify the igniting module 12 to ignite the lamp 11. Then the projector 10 may enter an active mode from the standby mode. The switch 16 is used for turning on/off the power of the projector 10 and switching into different modes in a manual manner.

Pins of the input port 14 of the projector 10 and pins of the output port 31 of the video source 30 may be pre-defined. The pins of the input port 14 and the output port 31 correspond to each other. Some of the pins are used for transmitting video signals, and pins which are grounded or unused may be selected for defining. The defined pin corresponding to different input ports may be changed according to different types of the video signals; for example, pin 5 is usable in a VGA port, pin 15 is usable in a DVI port, and pin 19 is usable in an HDMI port.

When the video signal cable 20 connects the active video source 30 and the projector 10 in the standby mode, electrical signals may be transmitted from the defined pin of the output port 31 of the video source 30 to the defined pin of the input port 14 of the projector 10 via the video signal cable 20. Therefore, the projector 10 may have connected to the active video source 30, according to the defining signal detected from the defined pin of the input port 14 by the microprocessor 15. The defining signal is selected from one of the following: a current variation, a voltage variation, an encoded signal, a clock signal, and a synchronous signal. But please note that the scope of the present invention is not limited to the above description.

For the voltage variation, assume that the microprocessor 15 may obtain an initial potential by detecting the defined pin of the input port 14 before the projector 10 connects electronically to the video source 30 via the video signal cable 20. The initial potential may be high or low. When the input port 14 connects to the active video source 30 via the video signal cable 20, the voltage variation of the defined pin may be detected by the microprocessor 15; for example, the potential is changed from high potential to low potential or from low potential to high potential. Accordingly, the microprocessor 15 may determine that the projector 10 has connected to the active video source 30, and notify elements of the projector 10 to enter the active mode.

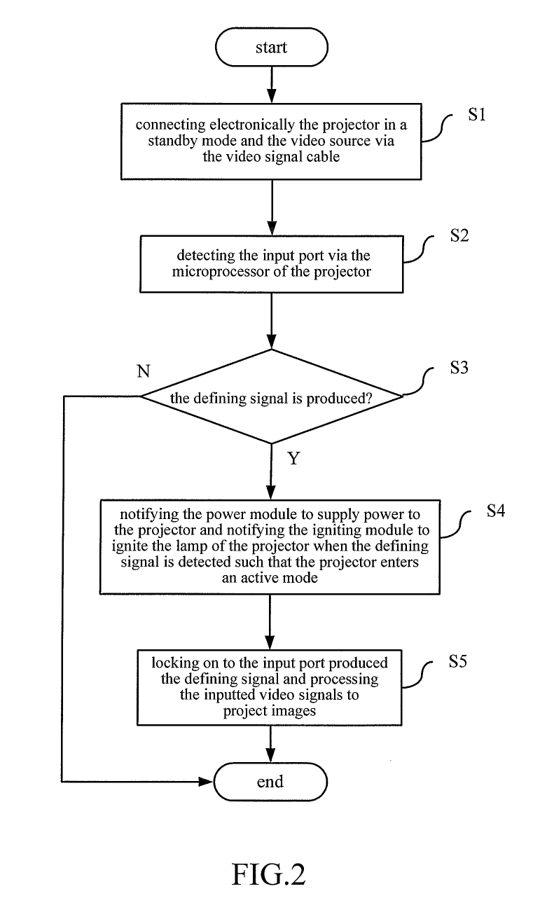

Please refer to FIG. 2 for a main flowchart of a projector control method of the present invention. It is noted that although the following description uses the projector 1 in FIG. 1 to illustrate the projector control method, the present invention is not limited to using the projector 1. As shown in FIG. 2, the projector control method comprises step S1 to step S5. The following will explain the various steps in detail.

Step S1: Connecting electronically the projector 10 in a standby mode and the video source 30 via the video signal cable 20. As shown in FIG. 1, the projector control method of the present invention is used for a projector 1 in a standby mode. When the projector 1 connects to the power source via a power cable (not shown), the projector 1 may enter the standby mode from a power failure status. The user may connect the output port 31 of the video source 30 to one end of the video signal cable 20, and connect the input port 14 of the projector 10 to another end of the video signal cable 20. Therefore, an electrical circuit between the video source 30 and the projector 10 may be formed for transmitting video signals or other electrical signals.

Step S2: Detecting the input port 14 via the microprocessor 15 of the projector 10. When the projector 10 enters the standby mode, the power module 13 may supply some power to the microprocessor 15 for detecting signals through the defined pin of the input port 14.

Step S3: Detecting whether the defining signal is produced from the input port 14 of the projector 10. As shown in FIG. 1, when the video signal cable 20 connects to the output port 31 of the active video source 30, the video source 30 may continuously transmit video signals via the video signal cable 20. When the projector 10 is in the standby mode, the microprocessor 15 may detect the status of the defined pin of the input port 14 in real-time. Therefore, when the video signal cable 20 connects to the input port 14 of the projector 10, the defining signal may be produced from the defined pin of the input port 14 according to the aforementioned design of the defined pin and electrical signals transmitted from the video source 30. The defining signal may be, but is not limited to, a current variation, a voltage variation, or a specific encoded signal. At this moment, the microprocessor 15 may detect the occurrence of the defining signal and execute the following process.

Step S4: Notifying the power module 13 to supply power to the projector 10 and notifying the igniting module 12 to ignite the lamp 11 of the projector 10 when the defining signal is detected, such that the projector 10 enters an active mode. As shown in FIG. 1, when the defining signal is detected in Step S3, the microprocessor 15 may send commands to notify the power module 13 and the igniting module 12. The power module 13 may supply power to the projector 10, and the igniting module 12 may ignite the lamp 11 according to the commands. Then the projector 10 may enter the active mode from the standby mode for projecting images.

Step S5: locking on to the input port 14 that produced the defining signal and processing the inputted video signals to project images. As shown in FIG. 1, when the projector 10 enters the active mode, the input port 14 may be locked on to. The video signals may be transmitted from the video source 30 via the video signal cable 20 and be inputted into the projector 10 via the input port 14. The corresponding image processing for the video signals may be executed and images of the video signals may be projected by the lamp 11.

Accordingly, when the video signal cable 20 connects the active video source and the projector 10, the projector 10 may enter the active mode from the standby mode. The users need not operate any remote control device or turn on the power switch 16 of the projector 10. It is more convenient for users to operate the projector 10.

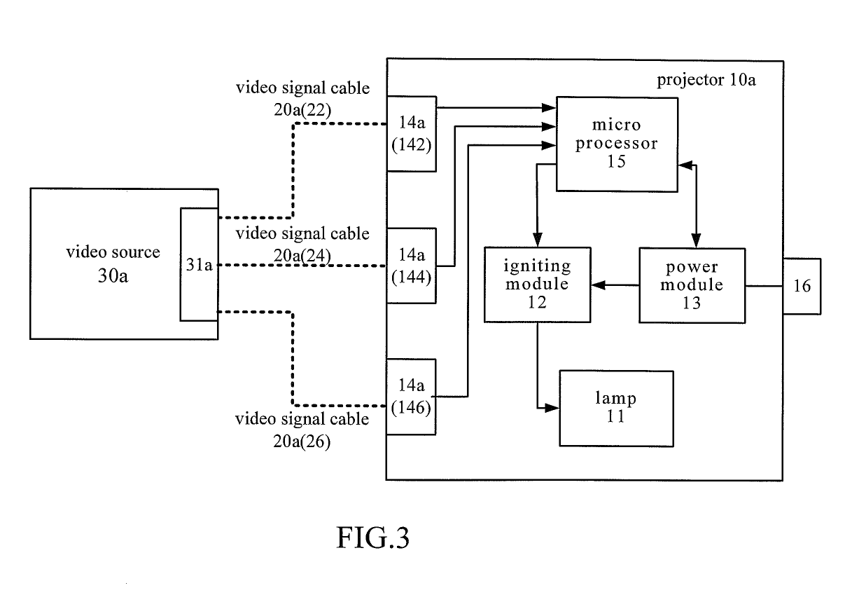

Please refer to FIG. 3 for a schematic drawing of using another embodiment of a projector 10a of the present invention. This embodiment is a modification of the aforementioned embodiment. As shown in FIG. 3, the projector 10a of the present invention comprises a plurality of input ports 14a for receiving different types of video signals or connecting to different video sources 30a. In this embodiment, the plurality of input ports 14a comprises a first input port 142, a second input port 144, and a third input port 146. The first input port 142 corresponds to a VGA cable, the second input port 144 corresponds to a DVI cable, and the third input port 146 corresponds to an HDMI cable. The user may select the suitable video signal cable 20a (e.g. the video signal cables 22, 24, 26 corresponding respectively to transmitting VGA signals, DVI signals, and HDMI signals) to connect to the corresponding input port 14a according to the different types of the output port 31a of the video source 30a or different results. But please note that the number and types of the input ports 14a of the present invention are not limited to the above description.

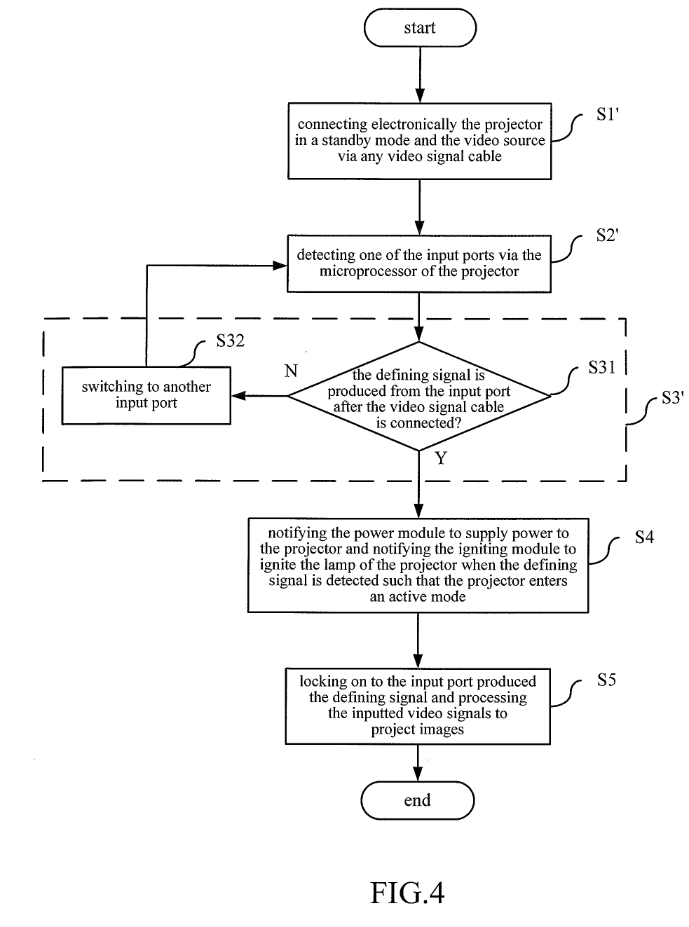

Please refer to FIG. 4 for a main flowchart of the projector control method of the present invention applied to another embodiment of the projector 10a. It is noted that although the following description uses the projector 10a in FIG. 3 to illustrate the projector control method, the present invention is not limited to using the projector 10a. As shown in FIG. 3, the projector control method comprises step S1′ to step S5. The steps S1′, S2′, and S3′ in FIG. 4 are different from the corresponding steps in FIG. 2. The following will explain the various steps with differences between FIG. 2 and FIG. 4 in detail.

Step S1′: Connecting electronically the projector 10a in the standby mode and the video source 30a via any video signal cable 20a. As shown in FIG. 3, the projector 10a comprises a plurality of input ports 14a supporting to different signal interfaces (e.g. the first input port 142 supports a VGA interface, the second input port 144 supports a DVI interface, and the third input port 146 supports an HDMI interface). The user may select one of the video signal cables 22, 24, or 26 to connect correspondingly to the output port 31a of the video source 30a and the input port 14a of the projector 10a. Therefore, an electrical circuit between the video source 30a and the projector 10a may be formed. For example, when the video signal cable 26 supporting HDMI signals is selected, the video signal cable 26 may connect to the third input port 146 with the HDMI interface.

Step S2′: Detecting one of the input ports 14a via the microprocessor 15 of the projector 10a. The projector 10a comprises the plurality of input ports 14a. When the projector 10a enters the standby mode, the microprocessor 15 may select one of the input ports 14a first to detect the signals through the defined pin of the selected input port 14a.

Step S3′: Detecting whether the defining signal is produced from one of input port 14a of the projector 10a. Furthermore, step S3 comprises:

Step S31′: Determining whether the defining signal is produced from the input port 14a after the video signal cable 20a is connected.

Step S32′: Switching to another input port 14a.

As shown in FIG. 3, for the plurality of the input ports 14a, the microprocessor 15 may detect each input port 142, 144, 146 in sequence. Assuming the first input port 142 of the projector 10a is connected to the output port 31a of the video source 30a via the video signal cable 22, the defining signal produced from the defined pin of the first input port 142 may be detected by the microprocessor 15. Then the following step S4 of the method may be executed.

Assume that the second input port 144 of the projector 10a is connected to the output port 31a of the video source 30a via the video signal cable 24. When the microprocessor 15 detects the first input port 142 first and determines that the defining signal is not produced, step S32′ may be executed to switch another input port 14a, e.g. the second input port 144 or the third input port 146, and then return to step S2′ again to detect the selected input port. When the defining signal produced from the defined pin of the first input port 144 may be detected by the microprocessor 15, the microprocessor 15 may stop to detect other input ports 14a. Accordingly, in this embodiment, the microprocessor 15 may detect each input port 14a continuously until the defining signal produced from any input port 14a is detected. Furthermore, steps S4 and S5 in FIG. 4 are the same as the corresponding steps in FIG. 2.

Although the present invention has been explained in relation to its preferred embodiments, it is to be understood that many other possible modifications and variations can be made without departing from the spirit and scope of the invention as hereinafter claimed.

What is claimed is:

1. A projector control method for a projector in a standby mode, the projector connecting to an active video source for image projecting and comprising at least one input port, the method comprising the follow steps of:
connecting electronically the projector and the video source via a video signal cable;
detecting whether a defining signal is produced from the input port of the projector, wherein the defining signal is selected from one of the following: a current variation, a voltage variation, an encoded signal, a clock signal, and a synchronous signal; and
supplying power to the projector and igniting a lamp when the defining signal is detected, such that the projector enters an active mode.

2. The projector control method as claimed in claim 1, wherein a defined pin of the input port connected to the video signal cable may be detected to determine whether the defining signal is produced.

3. The projector control method as claimed in claim 2, wherein the defining signal is detected by a microprocessor of the projector.

4. The projector control method as claimed in claim 3, wherein when the defining signal is detected, the microprocessor notifies a power module to supply power to the projector, and notifies an igniting module to ignite the lamp.

5. The projector control method as claimed in claim 4, wherein the microprocessor may lock on to the input port producing the defining signal and process video signals inputted into the projector via the input port so as to project images of the video signals.

6. The projector control method as claimed in claim 2, wherein the projector comprises a plurality of input ports; when the defining signal is not detected from one of the input ports, other input ports may be detected continuously to determine whether any input port is connected to the video source via any video signal cable; and the detection for the defining signal may be stopped when the defining signal is detected from any input port connected to the video signal cable.

7. A projector connecting electronically to an active video source via a video signal cable, the projector comprising:
a lamp;
an igniting module for igniting the lamp;
a power module for supplying power to the projector;
at least one input port for connecting the video signal cable; and
a microprocessor connected electronically to the igniting module, the power module, and the at least one input port, wherein the microprocessor detects each input port to determine whether a defining signal is produced in order to determine the input port connected to the video source, wherein the defining signal is selected from one of the following: a current variation, a voltage variation, an encoded signal, a clock signal, and a synchronous signal; then the microprocessor notifies the power module to supply power to the projector, and notifies the igniting module to ignite the lamp, such that the projector enters an active mode from a standby mode.

8. The projector as claimed in claim 7, wherein the microprocessor detects whether the defining signal is produced from a defined pin of each input port.

9. The projector as claimed in claim 8, wherein the projector comprises a plurality of input ports, when the defining signal is not detected from one of the input ports by the microprocessor, the microprocessor may detect continuously other input ports to determine whether any input port is connected to the video source via any video signal cable; and the microprocessor may stop to detect the defining signal when the defining signal is detected from any input port connected to the video signal cable.
